(19) United States
(12) Patent Application Publication
(10) Pub. No.: US 2026/0050828 A1
(43) Pub. Date: Feb. 19, 2026

(54) DATA PROCESSING METHOD USING DIMENSIONALITY REDUCTION

(71) Applicant: SAMSUNG ELECTRONICS CO., LTD., SUWON-SI (KR)

(72) Inventors: Dongun Yun, Suwon-si (KR); Euiseok Kum, Suwon-si (KR); Sujeong Kim, Suwon-si (KR); Jihye Park, Suwon-si (KR); Hyunseop Park, Suwon-si (KR); Haneul Yoo, Suwon-si (KR); Jaeyoong Lim, Suwon-si (KR); Sungmin Cho, Suwon-si (KR); Insoo Choi, Suwon-si (KR)

(21) Appl. No.: 19/018,081

(22) Filed: Jan. 13, 2025

(30) Foreign Application Priority Data
Aug. 16, 2024 (KR) 10-2024-0110061

(51) Int. Cl. G06N 20/00

(52) U.S. Cl. CPC G06N 20/00

(57) ABSTRACT

A data processing method including receiving obtaining multidimensional data including a plurality of parameters of a wafer, generating a principal component and a loading vector based on the multidimensional data, wherein the principal component represents dimensionally reduced characteristics of the of the multidimensional data and the loading vector represents a weight of the principal component to the multidimensional data, generating a guide line based on a first group of parameters among the plurality of parameters and a second group of parameters among the plurality of parameters, and generating an analysis result of a parameter among the plurality of parameters of the wafer based on the guide line and the loading vector.

### CROSS-REFERENCE TO RELATED APPLICATION

This U.S. non-provisional patent application claims priority under 35 U.S.C. § 119 to Korean Patent Application No. 10-2024-0110061, filed on Aug. 16, 2024, in the Korean Intellectual Property Office, the disclosure of which is incorporated by reference herein in its entirety.

### BACKGROUND

Embodiments of the present disclosure relate to a data processing method, and more particularly, to a multidimensional data processing method.

To manufacture semiconductor devices, a target semiconductor pattern is formed on a semiconductor substrate using various semiconductor processes. For example, these semiconductor processes include photolithography, etching, ashing, ion implantation, thin-film deposition, and cleaning.

To evaluate the semiconductor process, measurements may be performed on a substrate during the semiconductor process and/or after the semiconductor process has been performed. Data obtained from the measurements may be multidimensional data with a plurality of parameters. To analyze the multidimensional data, a dimensionality reduction algorithm may be used to transform high-dimensional data into low-dimensional data.

### SUMMARY

A data processing method including obtaining multidimensional data including a plurality of parameters, generating, using a machine learning processor, a principal component and a loading vector based on the multidimensional data, wherein the principal component represents dimensionally reduced characteristics of the of the multidimensional data and the loading vector represents a weight of the principal component to the multidimensional data, generating a guide line based on a first group of parameters among the plurality of parameters and a second group of parameters among the plurality of parameters, and generating an analysis result of the plurality of parameters based on the guide line and the loading vector.

A data processing method including obtaining multidimensional data including a plurality of parameters, generating, using a machine learning processor, a principal component and a loading vector based on the multidimensional data, wherein the principal component represents dimensionally reduced characteristics of the of the multidimensional data and the loading vector represents a weight of the principal component to the multidimensional data, generating a guide line based on a first group of parameters among the plurality of parameters and a second group of parameters among the plurality of parameters, and generating an analysis result of the plurality of parameters based on a similarity between the guide line and the loading vector.

A data processing method including obtaining multidimensional data including a plurality of parameters, generating, using a machine learning processor, a principal component and a loading vector based on the multidimensional data, wherein the principal component represents dimensionally reduced characteristics of the of the multidimensional data and the loading vector represents a weight of the principal component to the multidimensional data, generating a data plane based on the multidimensional data and the principal component, generating a guide line based on a first group of parameters among the plurality of parameters and a second group of parameters among the plurality of parameters, generating an analysis result of the plurality of parameters based on data plane, the guide line, and the loading vector.

### BRIEF DESCRIPTION OF THE DRAWINGS

FIG. 1 is a flowchart of a data processing method according to an embodiment of the present disclosure.

FIG. 2 is a diagram illustrating a substrate processing device for measuring sensor data and optical emission spectrometry (OES) data according to an embodiment of the present disclosure.

FIG. 3 is a flowchart of a method of analyzing multidimensional data according to an embodiment of the present disclosure.

FIG. 4 is a diagram illustrating the setting of a guide line on a data plane according to an embodiment of the present disclosure.

FIG. 5 is a diagram illustrating the calculation of similarities between a guide line and loading vectors according to an embodiment of the present disclosure.

FIG. 6 is a diagram illustrating a biplot that represents dimensionally reduced data according to an embodiment of the present disclosure.

FIG. 7 is a block diagram of a data processing device according to an embodiment of the present disclosure.

### DETAILED DESCRIPTION OF THE EMBODIMENTS

Hereinafter, embodiments of the inventive concept are described in detail with reference to the accompanying drawings. The same reference numerals are used for the same components in the drawings, and redundant descriptions thereof may be omitted.

It will be understood that, although the terms “first,” “second,” etc. may be used herein to describe various elements, these elements should not be limited by these terms. These terms are only used to distinguish one element from another element. For example, a first element discussed below could be termed a second element without departing from the teachings and spirit of the present disclosure. Similarly, the second element could also be termed the first element.

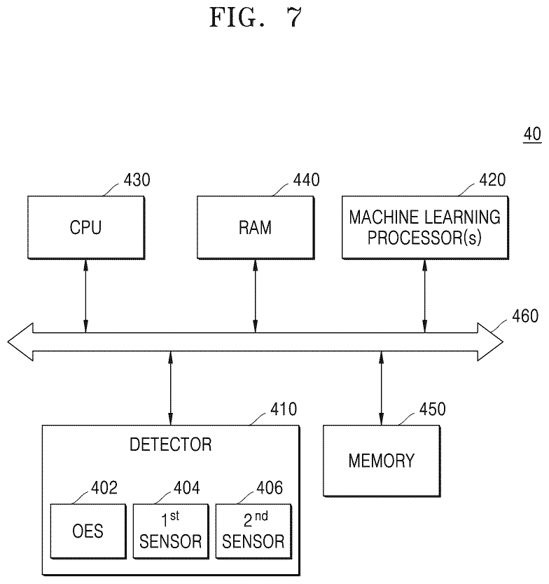

Embodiments of the present disclosure provide a method and system for data processing using dimensionality reduction. In some aspects, the system (e.g., the data processing device 40 described with reference to FIG. 7) obtains a multidimensional data (or input data) including a plurality of parameter and performs a dimensionality reduction using a machine learning processor to efficiently analyze the input data. In some aspects, the machine learning processor may be trained or configured to perform dimensionality reduction by using principal component analysis (CPA). Accordingly, the system is able to convert the multidimensional data in high-dimensional space into a low-dimensional space.

In some aspects, the system generates one or more principal components that represent the dimensionally reduced characteristics of the multidimensional data and one or more loading vectors that represent a weight of the principal component to the multidimensional data. The system further generates a data plane based on the multidimensional data and the principal component, where the multidimensional data can be represented in the low-dimensional space. The system further generates a guide line on the data plane, where the guide line serves as a reference for analyzing the difference between groups of data and relationships between parameters.

In some aspects, the system generates an analysis result based on the loading vector and the guide line, where the analysis result is used to efficiently analyze the input data. For example, the system generates a plurality of loading vectors, and ranks each of the loading vectors to the guide line based on the similarity, angle, magnitude, or a combination thereof. Accordingly, system and method of the present disclosure can efficiently analyze an input data including a plurality of parameters by performing a dimensionality reduction on the input data. Moreover, the efficiency of the processor of the computing system can be increased by analyzing the data in low-dimensional space.

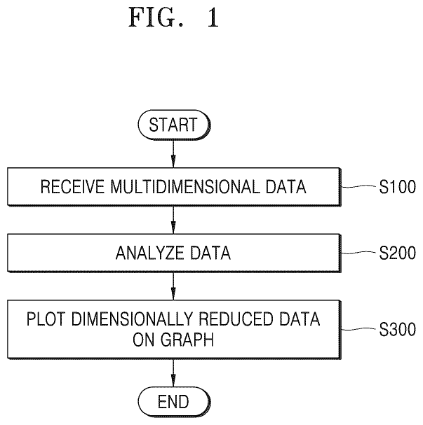

FIG. 1 is a flowchart of a data processing method according to an embodiment of the present disclosure. Referring to FIG. 1, at operation 100 (S100), the system receives multidimensional data. The multidimensional data may be data that includes a plurality of dimensions. For example, the multidimensional data may include recorded sensor data of a wafer during the performance of a semiconductor process, measurement data of a wafer sampled from among wafers on which a semiconductor process has been performed, and/or optical emission spectrometry (OES) data of a wafer. In some aspects, the multidimensional data may be data of a wafer during a semiconductor process or after a semiconductor process.

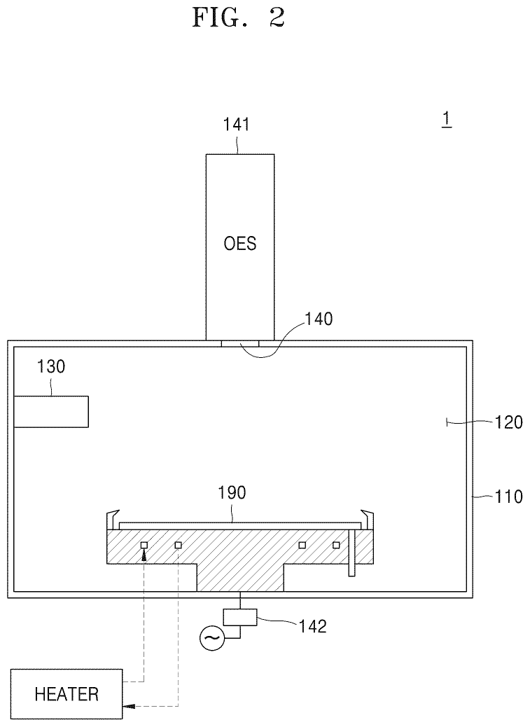

The multidimensional data may have a plurality of parameters. For example, the multidimensional data may have thousands or more parameters. Hereinafter, a method of effectively processing data having a plurality of parameters is described. For example, a method of measuring sensor data and OES data of a wafer from among the above examples of multidimensional data is described with reference to FIG. 2.

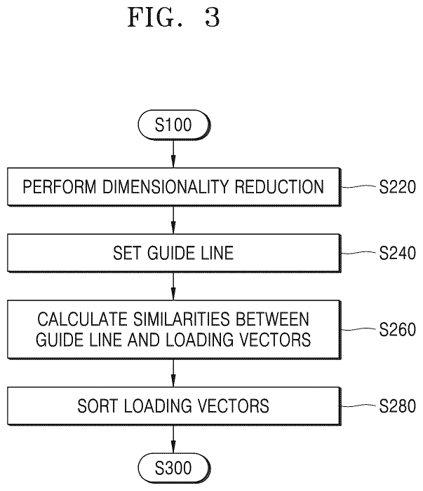

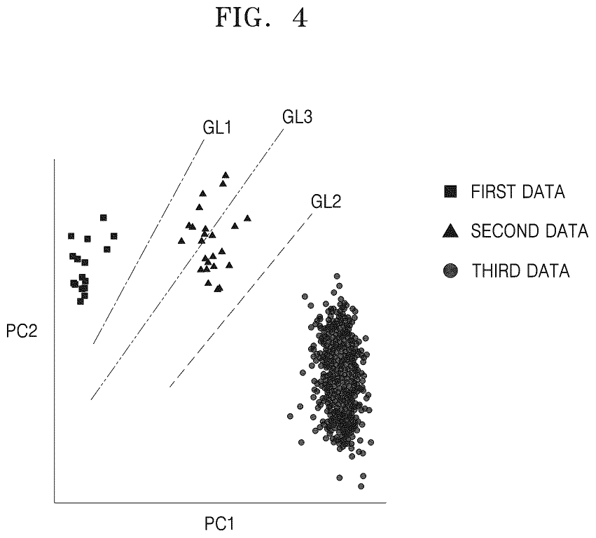

At operation 200 (S200), the system analyzes data. In some embodiments, analyzing data includes performing dimensionality reduction, setting guide line, calculating similarities between guide line and loading vectors, and sorting loading vectors. Further detail on analyzing the data is described with reference to FIG. 3. At operation 300 (S300), the system plots the dimensionally reduced data on graph. Further detail on plotting the dimensionally reduced data on graph is described with reference to FIGS. 4-6.

FIG. 2 is a diagram illustrating a substrate processing device for measuring sensor data and OES data according to an embodiment of the present disclosure. Referring to FIG. 2, a substrate processing device 1 (or substrate processing apparatus) may include a chamber 110, a plasma source 130, an optical emission spectrometer (OES) 141, and a sensor 142.

In the present disclosure, “substrate” may refer to a substrate or a stack structure including a substrate and a layer, film, or the like formed on the surface of the substrate. In some cases, “the surface of a substrate” may refer to an exposed surface (or region) of the substrate, or an exposed surface (or region) of a layer, film, or the like formed on the substrate. For example, a substrate may be a wafer or may include a wafer and at least one material film on the wafer. The material film may include an insulating film and/or a conductive film formed on a wafer through various methods such as deposition, coating, or plating. For example, the insulating film may include an oxide film, a nitride film, an oxynitride film, or the like. For example, the conductive film may include a metal film, a polysilicon film, or the like. In some cases, the material film may include a single film or multiple films formed on the wafer. In some cases, the material film may be formed on the wafer with a target pattern.

The chamber 110 may provide a space for performing a semiconductor process on a substrate 190. The semiconductor process may include an etching process, a deposition process, and/or a cleaning process. For example, the chamber 110 may include a processing space 120 in which the substrate 190 is processed. The processing space 120 may be sealed from the outside of the chamber 110. In some embodiments, the chamber 110 may be a vacuum chamber. The outer structure of the chamber 110 may have a cylindrical, elliptical, or polygonal column shape. The chamber 110 may generally include a metal material. The chamber 110 may also maintain an electrical ground state to block noise from the outside during various semiconductor processes.

In some cases, the chamber 110 may be a chamber for a plasma process using plasma, such as dry etching, plasma-enhanced chemical vapor deposition (PECVD), sputtering, or ashing. In some cases, the chamber 110 may include various types of plasma chambers, such as a capacitively coupled plasma (CCP) chamber, an inductively coupled plasma (ICP) chamber, an electron cyclotron resonance (ECR) plasma chamber, a surface wave plasma (SWP) chamber, a helicon wave plasma chamber, or an electron beam (e-beam) plasma chamber.

A liner may be disposed inside the chamber 110. The liner may protect the chamber 110 and cover metal structures within the chamber 110 to prevent metal contamination due to arcing within the chamber 110. The liner may include a metal material such as aluminum, or a ceramic material.

The plasma source 130 may be disposed on an inner wall of the chamber 110. The plasma source 130 may generate plasma for processing the substrate 190. For example, the plasma source 130 may generate plasma from process gas supplied into the processing space 120 of the chamber 110. In an embodiment, the plasma source 130 may be disposed outside the chamber 110. The arrangement of the plasma source 130 may vary based on the design of the substrate processing device 1. When the condition in the chamber 110 is determined to be normal, the plasma source 130 may perform a plasma processing operation of processing the substrate 190 within the chamber 110 with plasma.

An optical view port 140 may be disposed on an upper wall of the chamber 110. Light may be transmitted from the optical view port 140 to the OES 141 through an optical fiber. The optical view port 140 may be disposed at a position spaced apart from the upper surface of the substrate 190 in a vertical direction, where the vertical direction is perpendicular to the upper surface of the substrate 190. FIG. 2 illustrates that the optical view port 140 is arranged at a position spaced apart from a central region of the substrate 190 in the vertical direction, but the technical spirit of the inventive concept is not limited thereto.

In the present disclosure, a direction parallel to a upper surface of the substrate 190 may be a horizontal direction (e.g., X direction and/or Y direction), and a direction perpendicular to the horizontal direction (e.g., X direction and/or Y direction) may be a vertical direction (e.g., Z direction).

The OES 141 may be disposed on an upper wall of the chamber 110. The OES 141 may be disposed on an outer wall of the chamber 110. The OES 141 may measure data of a substrate (e.g., substrate 190). For example, OES 141 measures the elemental composition of materials by analyzing the light emitted when the substrate 190 is excited by an energy source (e.g., the plasma generated from plasma source 130 during or after a semiconductor manufacturing process).

The substrate processing device 1 may further include the sensor 142 configured to measure physical characteristics of the substrate 190. In an embodiment, the sensor 142 may measure an etch depth of the substrate 190, the width of a pattern, and a critical dimension (CD) in a semiconductor etching process. However, the physical characteristics measured by the sensor 142 are not limited thereto, and the sensor 142 may measure various types of physical characteristics.

Data obtained by the OES 141 and the sensor 142 may correspond to the multidimensional data in operation S100. The multidimensional data may be data having a plurality of parameters. For example, multidimensional data may be obtained by receiving data obtained from the OES 141 and the sensor 142. For example, the multidimensional data may include parameters such as wavelength and/or time. For example, when an etching process is performed, the multidimensional data may include parameters such as a voltage, a current, and/or a phase applied to the chamber 110. However, the technical spirit of the inventive concept is not limited thereto, and the multidimensional data may have various parameters. In an embodiment, while changing the parameters described above, the intensity of light, an etch depth of the substrate 190, the width of a pattern, and a critical dimension (CD) of the pattern may be measured.

In a semiconductor process, the OES 141 may measure a chemical reaction of reaction gas, ion density, electron temperature of plasma, and concentrations of various chemically active substances in real time. The OES 141 may collect spectrum data by exciting the substrate 190, emitting light from the substrate 190, collecting the emitted light, and detecting the wavelength of light detected at a particular wavelength and generating a spectrum. Spectrum data may be obtained by measuring an optical signal transmitted through an optical fiber in the optical view port 140 of the substrate processing device 1 using the OES 141.

The spectrum data may be spectrum data including the intensity of an optical signal for each wavelength obtained by performing spectroscopic analysis of the optical signal using the OES 141. The spectrum data may be spectrum data including the intensity of an optical signal for each process time slot. For example, the spectrum data may be spectrum data including the intensity of an optical signal according to a wavelength axis and a time axis.

Referring back to FIG. 1, after the receiving of the multidimensional data (S100), the system analyzes multidimensional data at operation 200 (S200). Analyzing the multidimensional data may include performing dimensionality reduction on the multidimensional data, and determining a parameter based on a difference between grouped pieces of data.

Analyzing the multidimensional data (S200) is described in more detail with reference to FIG. 3. FIG. 3 is a flowchart of a method of analyzing multidimensional data according to an embodiment of the present disclosure.

At operation 220 (S220), the system performs dimensionality reduction on the data. Reduction of the dimensionality of data may be transformation of high-dimensional data into a lower-dimensional space. For example, reduction of the dimensionality of data may be performed by a principal component analysis (PCA) algorithm and/or a partial least squares (PLS) algorithm. PCA is a method of reducing the dimensionality of high-dimensional data while preserving the variability of the data. In some aspects, PCA transforms data into a minimum number of variables. PLS is a method of simultaneously performing dimensionality reduction and regression analysis after finding latent variables that maximize the covariance between predictor variables and response variables.

However, the technical spirit of the inventive concept is not limited thereto, and various algorithms may be used for reduction of the dimensionality of data. For example, reduction of the dimensionality of data may be performed based on algorithms such as embedding, linear discriminant analysis (LDA), autoencoder, and/or t-distributed stochastic neighbor embedding (t-SNE).

For example, when reduction of the dimensionality of data is performed by a PCA algorithm, loading vectors of the principal components may be calculated. The loading vectors may be coefficients indicating the degree to which parameters of original data (multidimensional data) contribute to new principal components. Even when dimensionality reduction is performed by using the above examples of algorithms other than PCA, a coefficient indicating the degree to which each parameter contributes to a new dimensionality may be calculated.

In some cases, the system performs a data reduction using a PCA algorithm to generate principal components based on the obtained data. Principal components includes most variation in the original data. For example, when analyzing the data obtained from the sensor 142, a first principal component may include information or data of the overall physical characteristic (e.g., a combination of etch depth, the width of a pattern, and a critical dimension) of the substrate 190. The second principal component may include information or data that represents the remaining variation, such as the difference between etch depth, the width of a pattern, and a critical dimension of the substrate 190. The loading vector includes information or data that represents the weight of each physical characteristic contributes to the principal component.

For example, when data including n parameters is dimensionally reduced to two principal components, the two principal components may be represented by Equation 1 below:

$${Z}_{1} = {\sum }_{i = 1}^{n} {P}_{i} {X}_{i} , {Z}_{2} = {\sum }_{j = 1}^{n} {P}_{j} {X}_{i} \qquad [ Equation 1 ]$$

In Equation 1, Z₁ and Z₂ represent two principal components computed through dimensionality reduction, respectively, Pᵢ represents a loading vector of Z₁, Pⱼ represents a loading vector of Z₂, and Xᵢ represents a plurality of pieces of data.

Dimensionally reduced pieces of data may be grouped by parameters (e.g. process conditions). For example, pieces of first data having a first parameter may be grouped adjacent to each other, and pieces of second data having a second parameter may be grouped adjacent to each other. The pieces of first data and the pieces of second data may be plotted on a graph (a data plane) to be spaced apart from each other.

At operation 240 (S240), the system sets a guide line on the data plane. The data plane may be a plane on which the dimensionally reduced data is indicated. The data plane may include a graph with axes representing the respective reduced dimensions. Further detail on setting the guide line on the data plane is described with reference to FIG. 4.

FIG. 4 is a diagram illustrating the setting of a guide line on a data plane according to an embodiment of the present disclosure. In FIG. 4, the horizontal axis represents a first principal component PC1, and the vertical axis represents a second principal component PC2. FIG. 4 illustrates an example in which data is represented by using two principal components. However, the technical spirit of the inventive concept is not limited thereto, and multidimensional data may be represented by using three or more principal components. For example, multidimensional data may be represented in three or more dimensions.

Referring to FIG. 4, the data plane may have dimensionally reduced principal components as axes. The guide line may be an imaginary line for initiating the analysis of multidimensional data. In an embodiment, the guide line may be a straight line. The guide line may be set arbitrarily. In an embodiment, the guide line may form an angle other than 0° with each of a plurality of axes of the data plane. For example, the guide line may have a slope different from the slope of each of the plurality of axes of the data plane. For example, the guide line may not be parallel to each of the plurality of axes of the data plane. In an embodiment, the guide line may be parallel to at least one of the plurality of axes of the data plane.

In an embodiment, the guide line may be formed between pieces of grouped data that are spaced apart from each other in operation S220. FIG. 4 shows examples of pieces of first data (represented in square), second data (represented in triangle), and third data (represented in circle). The pieces of first to third data may include first to third parameter(s), respectively.

As described above, guide lines are lines that indicate differences between pieces of grouped data, and may be arbitrarily plotted. For example, a first guide line GL1 is plotted between the pieces of first data and the pieces of second data, a second guide line GL2 is plotted between the pieces of second data and the pieces of third data, and a third guide line GL3 is plotted between the pieces of first data and the pieces of third data. For example, the first guide line GL1 may facilitate determination of parameter(s) that indicates differences between the pieces of first data and the pieces of second data, the second guide line GL2 may facilitate determination of parameter(s) that indicates differences between the pieces of second data and the pieces of third data, and the third guide line GL3 may facilitate determination of parameter(s) that indicates differences between the pieces of first data and the pieces of third data.

However, this is merely an example, and the parameter(s) that indicates differences between the pieces of first data and the pieces of second data may be easily determined based on the second guide line GL2 and/or the third guide line GL3. Likewise, the parameter(s) that indicates differences between the pieces of second data and the pieces of third data may be easily determined based on the first guide line GL1 and/or the third guide line GL3. In some cases, the parameter(s) that indicates differences between the pieces of first data and the pieces of third data may be easily determined based on the first guide line GL1 and/or the second guide line GL2. For example, the guide lines may be set arbitrarily, and other guide lines than the guide lines illustrated in FIG. 4 may be set.

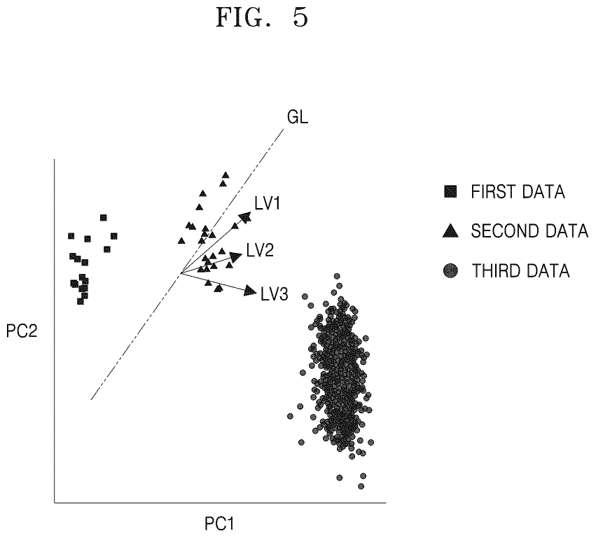

At operation 260 (S260), the system calculates similarities between the guide line and the loading vectors. Further detail on calculating the similarities between the guide line and the loading vectors is described with reference to FIG. 5.

FIG. 5 is a diagram illustrating the calculation of similarities between a guide line and loading vectors according to an embodiment of the present disclosure. In FIG. 5, the horizontal axis represents the first principal component PC1, and the vertical axis represents the second principal component PC2. FIG. 5 illustrates an example in which data is represented by using two principal components. However, the technical spirit of the inventive concept is not limited thereto, and multidimensional data may be represented by using three or more principal components. In FIG. 5, the guide line GL is plotted as a dotted line, and each of the plurality of loading vectors is plotted as an arrow. In some cases, for example, one guide line GL is plotted in FIG. 5.

Referring to FIG. 5, a similarity between the guide line GL and a loading vector may be calculated based on cosine similarity. The cosine similarity may be calculated based on Equation 2 below:

$$cosine similarity = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}} \qquad [ Equation 2 ]$$

where A denotes a guide line vector, and B denotes a loading vector (e.g., the first loading vector LV1, the second loading vector LV2, and/or the third loading vector LV3).

Here, the guide line vector may be a vector represented between arbitrary two points on the guide line GL. In an embodiment, the guide line vector may be a straight line vector represented between arbitrary two points on the guide line GL. In an embodiment, the guide line vector may be a unit vector. A unit vector is a vector having a magnitude of 1.

For example, based on the cosine similarity, the system calculates the angle between the guide line vector and the loading vector using the inner product of the guide line vector and the loading vector. As the cosine similarity between the guide line vector and the loading vector decreases (i.e., as the angle between the guide line vector and the loading vector increases), the similarity between the guide line vector and the loading vector may decrease. On the contrary, as the cosine similarity between the guide line vector and the loading vector increases (i.e., as the angle between the guide line vector and the loading vector decreases), the similarity between the guide line vector and the loading vector may increase.

At operation 280 (S280), the systems sorts the loading vectors. The loading vectors may be sorted in descending order based on the corresponding similarities to the guide line GL. For example, the loading vectors may be sorted based on the similarities to the guide line GL, with higher similarity first. One or more loading vectors may be selected from among the sorted loading vectors. For example, two loading vectors with high similarities may be selected from among the sorted loading vectors. The number of parameters of the selected loading vector may be variously modified.

For example, in FIG. 5, first, second, and third loading vectors LV1, LV2, and LV3 are plotted. The cosine similarity between the first loading vector LV1 and the guide line GL may be greater than both the cosine similarities between the second loading vector LV2 and the guide line, and third loading vector LV3 and the guide line GL. In some cases, the cosine similarity between the second loading vector LV2 and the guide line GL may be greater than the cosine similarity between the third loading vector LV3 and the guide line GL. Thus, the first to third loading vectors LV1, LV2, and LV3 may be sorted in the order of the first loading vector LV1, the second loading vector LV2, and the third loading vector LV3.

In some cases, the loading vectors may be sorted based on the corresponding magnitudes. For example, the loading vectors may be sorted based on the similarities between the loading vectors and the guide line, and the magnitudes of the loading vectors. In an embodiment, as the magnitude of the loading vector increases, the priority of the loading vector may increase. On the contrary, as the magnitude of the loading vector decreases, the priority of the loading vector may decrease.

For example, among the first, second, and third loading vectors LV1, LV2, and LV3 of FIG. 5, the magnitudes of the first loading vector LV1 and the third loading vector LV3 may be greater than the magnitude of the second loading vector LV2. Thus, the first loading vector LV1 and the third loading vector LV3 may have higher priorities than the second loading vector LV2.

According to some embodiments, operations S240 to S280 may be performed repeatedly a plurality of times. For example, operations S240 to S280 may be performed repeatedly a plurality of times for different guide lines GL. The different guide lines GL may have different slopes from each other. In an embodiment, operations S240 to S280 may be performed repeatedly a plurality of times while rotating the guide line GL clockwise (or counterclockwise).

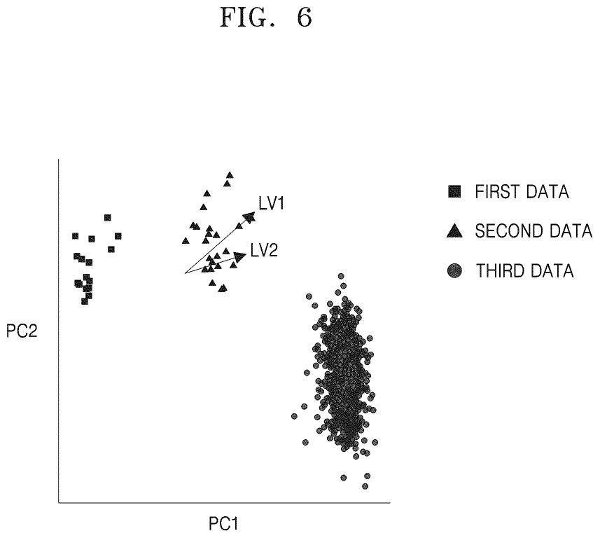

Referring back to FIG. 1, at operation 300 (S300), the dimensionally reduced data may be plotted on the graph. In an embodiment, the graph may include a biplot. The biplot may include points and arrows. The multidimensional data may be represented as points on the biplot. A parameter may be represented as an arrow on the biplot. The magnitude of a vector may correspond to the contribution of a parameter (i.e., a loading vector). The graph may have dimensionally reduced principal components as axes. The loading vector represented on the biplot may be a loading vector generated by performing operations S240 to S280. Further detail on the biplot is described with reference to FIG. 6.

FIG. 6 is a diagram illustrating a biplot that represents dimensionally reduced data according to an embodiment of the present disclosure. In FIG. 6, the horizontal axis represents the first principal component PC1, and the vertical axis represents the second principal component PC2. FIG. 6 illustrates an example in which data is represented by using two principal components. However, the technical spirit of the inventive concept is not limited thereto, and multidimensional data may be represented by using three or more principal components.

Referring to FIG. 6, dimensionally reduced data is plotted on a biplot. In some cases, for example, among the first, second, and third loading vectors LV1, LV2, and LV3 of FIG. 5, the first and second loading vectors LV1 and LV2 are plotted. The number of loading vectors plotted on the biplot is not limited thereto, and one, three, or more loading vectors may be plotted on the biplot.

In some cases, a parameter corresponding to a selected loading vector may be represented on the arrow. For example, a first parameter corresponding to the first loading vector LV1 and a second parameter corresponding to the second loading vector LV2 may be represented. As data is dimensionally reduced and then plotted on a biplot, and a parameter corresponding to a loading vector and the magnitude of the loading vector are plotted, multidimensional data may be easily analyzed.

The data processing method of the inventive concept may easily calculate parameters that indicates differences between pieces of grouped data in dimensionally reduced multidimensional data by using a guide line. For example, by calculating a loading vector having a slope similar to the guide line, a parameter included in the loading vector may be easily calculated. The calculated parameter may be a parameter that indicates differences between the pieces of grouped data.

FIG. 7 is a block diagram of a data processing device according to an embodiment of the present disclosure. Referring to FIG. 7, a data processing device 40 may process data by using a machine learning model. The data processing device 40 may include a detector 410, a machine learning processor 420, a central processing unit (CPU) 430, random-access memory (RAM) 440, a memory 450, and a bus 460. In one aspect, the detector 410 includes an OES 402, a first sensor 404, and a second sensor 406.

According to an embodiment, the data processing device 40 may further include other general-purpose components in addition to the components illustrated in FIG. 7. For example, the data processing device 40 may further include an input/output module, a security module, a power control device, and the like, and may also further include various types of processors. In some embodiments, at least one of the components illustrated in FIG. 7 may be omitted from the data processing device 40. The components of the data processing device 40 may communicate with each other via the bus 460.

The detector 410 may measure data of the substrate 190. In an embodiment, the detector 410 may obtain recorded sensor data of a wafer while a semiconductor process is performed, measurement data of a wafer sampled from among wafers on which a semiconductor process has been performed, and/or OES data of a wafer. The detector 410 may include an OES 402, a first sensor 404, and a second sensor 406. The data obtained by the detector 410 may be multidimensional data.

The OES 402 may measure OES data regarding the substrate 190. The OES 402 may measure the intensity of light at a plurality of wavelengths. The first sensor 404 may measure data of the substrate 190 within the chamber 110. In some cases, the second sensor 406 may measure data of the substrate 190 on which a semiconductor process has been performed. For example, the first sensor 404 and/or the second sensor 406 may measure an etch depth, the width of a pattern, and a critical dimension (CD) of the substrate 190 in a semiconductor etching process.

For example, the multidimensional data may have a wavelength and/or a time as parameters. For example, when an etching process is performed, the multidimensional data may have, as parameters, a voltage, a current, and/or a phase applied to the chamber 110. However, the technical spirit of the inventive concept is not limited thereto, and the data may have various parameters.

The machine learning processor 420 may be used to train (or learn) a machine learning model, or infer information included in input data by analyzing the input data by using the machine learning model. Based on the inferred information, the machine learning processor 420 may determine a situation or control a component of an electronic device on which the machine learning processor 420 is mounted.

In some cases, the machine learning processor 420 may receive input data from the detector 410 and/or the memory 450, and generate output data based on the received input data. The machine learning processor 420 may reduce the dimensionality of data.

In an embodiment, the data processing device 40 further includes an additional processor used to further reduce the dimensionality of the input data. The machine learning processor 420 may be implemented as a neural network operation accelerator, a coprocessor, a digital signal processor (DSP), an application-specific integrated circuit (ASIC), a field-programmable gate array (FPGA), a graphics processing unit (GPU), a neural processing unit (NPU), a tensor processing unit (TPU), a multi-processor system-on-chip (MPSoC), or the like.

In an embodiment, the machine learning processor 420 may perform machine learning algorithms such as PCA and/or PLS. The types of machine learning algorithms are not limited to the examples described above. For example, the machine learning processor 420 may perform machine learning algorithms such as embedding, LDA, autoencoder, and/or t-SNE.

In an embodiment, the machine learning processor 420 may perform neural network algorithms based on artificial neural network (ANN), convolutional neural network (CNN), region-based convolution neural network (R-CNN), 3D CNN, region proposal network (RPN), recurrent neural network (RNN), generative adversarial network (GAN), self-attention generative adversarial network (SAGAN), stacking-based deep neural network (S-DNN), state-space dynamic neural network (S-SDNN), deconvolution network, deep belief network (DBN), restricted Boltzmann machine (RBM), fully convolutional network, long short-term memory (LSTM), classification network, plain residual network, dense network, hierarchical pyramid network, region-based fully convolution network (RFCN), single shot multibox (SSD), You Only Look Once (YOLO), transformer network, and/or vision transformer network. The types of neural network models are not limited to the examples described above.

In some cases, the machine learning processor 420 is implemented in a machine learning model. For example, a machine learning model is a computational algorithm, model, or system designed to recognize patterns, make predictions, or perform a specific task (for example, image processing) without being explicitly programmed. According to some aspects, the machine learning model is implemented as software stored in a memory unit (e.g., the memory 450) and executable by a processor unit (e.g., the machine learning processor 420 or other processor(s)), as firmware, as one or more hardware circuits, or as a combination thereof.

In one aspect, machine learning model includes machine learning parameters. Machine learning parameters, also known as model parameters or weights, are variables that provide behaviors and characteristics of the machine learning model. Machine learning parameters can be learned or estimated from training data and are used to make predictions or perform tasks based on learned patterns and relationships in the data.

Machine learning parameters are adjusted during a training process to minimize a loss function or maximize a performance metric. The goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

According to some embodiments, the machine learning model includes a transformer (or a transformer model, or a transformer network), where the transformer is a type of neural network model used for natural language processing tasks. A transformer network transforms one sequence into another sequence using an encoder and a decoder. The encoder and decoder include modules that can be stacked on top of each other multiple times. The modules comprise multi-head attention and feed-forward layers. The inputs and outputs (target sentences) are first embedded into an n-dimensional space. Positional encoding of the different words (e.g., give each word/part in a sequence a relative position since the sequence depends on the order of its elements) is added to the embedded representation (n-dimensional vector) of each word. In some examples, a transformer network includes an attention mechanism, where the attention looks at an input sequence and decides at each step which other parts of the sequence are important.

The attention mechanism involves a query, keys, and values denoted by Q, K, and V, respectively. Q is a matrix that contains the query (vector representation of one word in the sequence), K are the keys (vector representations of the words in the sequence) and V are the values, which are again the vector representations of the words in the sequence. For the encoder and decoder, multi-head attention modules, V consists of the same word sequence as Q. However, for the attention module that takes into account the encoder and the decoder sequences, V is different from the sequence represented by Q. In some cases, values in V are multiplied and summed with some attention-weights.

During the training process, the one or more node weights are adjusted to increase the accuracy of the result (e.g., by minimizing a loss function that corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

The CPU 430 may control the operation of the data processing device 40. The CPU 430 may include a single processor core (single-core) or a plurality of processor cores (multi-core). The CPU 430 may process or execute programs and/or data stored in a storage area such as the memory 450 by using the RAM 440. For example, the CPU 430 may execute an application and control the machine learning processor 420 to perform machine learning-based tasks based on the execution of the application.

The memory 450 may store data regarding the substrate 190. The memory 450 may store data obtained by the detector 410. The memory 450 may include at least one of a volatile memory and a nonvolatile memory. The non-volatile memory includes read-only memory (ROM), programmable ROM (PROM), electrically programmable ROM (EPROM), electrically erasable and programmable ROM (EEPROM), flash memory, and the like. The volatile memory includes dynamic RAM (DRAM), static RAM (SRAM), synchronous DRAM (SDRAM), phase-change RAM (PRAM), magnetic RAM (MRAM), resistive RAM (RRAM), ferroelectric RAM (FRAM), and the like. In an embodiment, the memory 450 may include at least one of a hard disk drive (HDD), a solid-state drive (SSD), a CompactFlash (CF) card, a Secure Digital (SD) card, a micro-SD card, a mini-SD card, an extreme Digital (XD) card, or a memory stick.

Although the inventive concept has been described with reference to the embodiments shown in the drawings, the embodiments are merely exemplary, and it will be understood by those skilled in the art that various modifications and equivalent other embodiments are possible therefrom. Therefore, the true technical protection scope of the inventive concept should be determined by the appended claims.

While the inventive concept has been particularly shown and described with reference to embodiments thereof, it will be understood that various changes in form and details may be made therein without departing from the spirit and scope of the following claims.

What is claimed is:

1. A data processing method comprising:
obtaining multidimensional data including a plurality of parameters of a wafer;
generating, using a machine learning processor, a principal component and a loading vector based on the multidimensional data, wherein the principal component represents dimensionally reduced characteristics of the multidimensional data and the loading vector represents a weight of the principal component to the multidimensional data;
generating, using the machine learning processor, a guide line based on a first group of parameters among the plurality of parameters and a second group of parameters among the plurality of parameters; and
generating, using the machine learning processor, an analysis result of a parameter among the plurality of parameters of the wafer based on the guide line and the loading vector.

2. The data processing method of claim 1, wherein generating the principal component and the loading vector further comprises:
performing a principal component analysis (PCA) algorithm or a partial least squares algorithm on the multidimensional data.

3. The data processing method of claim 1, further comprising:
generating a data plane based on the multidimensional data and the principal component.

4. The data processing method of claim 1, further comprising:
generating a plurality of loading vectors;
ranking the plurality of loading vectors based on an angle between a guide line vector of the guide line and each of the plurality of loading vectors; and
selecting the loading vector based on the ranking.

5. The data processing method of claim 4, wherein ranking the plurality of loading vectors comprises:
computing cosine similarities between the guide line vector of the guide line and each of the plurality of loading vectors.

6. The data processing method of claim 4, wherein:
the guide line vector comprises a unit vector.

7. The data processing method of claim 1, wherein:
the guide line comprises a straight line.

8. A data processing method comprising:
obtaining multidimensional data including a plurality of parameters of a wafer;
generating, using a machine learning processor, a principal component and a loading vector based on the multidimensional data, wherein the principal component represents dimensionally reduced characteristics of the multidimensional data and the loading vector represents a weight of the principal component to the multidimensional data;
generating, using the machine learning processor, a guide line based on a first group of parameters among the plurality of parameters and a second group of parameters among the plurality of parameters; and
generating an analysis result of a parameter among the plurality of parameters of the wafer based on a similarity between the guide line and the loading vector.

9. The data processing method of claim 8, further comprising:
computing an angle between the guide line and the loading vector, wherein the angle represents the similarity between the guide line and the loading vector.

10. The data processing method of claim 8, further comprising:
generating a plurality of loading vectors; and
ranking the plurality of loading vectors based on magnitudes of the plurality of loading vectors.

11. The data processing method of claim 8, further comprising:
determining a priority of the loading vector based on a magnitude of the loading vector.

12. The data processing method of claim 8, further comprising:
generating a plurality of guide lines, wherein each of the plurality of guide lines has a different slope.

13. The data processing method of claim 12, wherein:
the plurality of guide lines includes a first guide line and a second guide line, wherein the second guide line is obtained by rotating the first guide line.

14. The data processing method of claim 8, wherein:
the guide line is arranged between the first group of parameters and the second group of parameters.

15. The data processing method of claim 8, further comprising:
generating a data plane based on the multidimensional data and the principal component, wherein the guide line is not parallel to each of a horizontal axis and a vertical axis of the data plane.

16. The data processing method of claim 8, wherein:
the analysis result is generated based on ranking a plurality of loading vectors in order of priority.

17. A data processing method comprising:
obtaining multidimensional data including a plurality of parameters of a wafer;
generating, using a machine learning processor, a principal component and a loading vector based on the multidimensional data, wherein the principal component represents dimensionally reduced characteristics of the multidimensional data and the loading vector represents a weight of the principal component to the multidimensional data;
generating a data plane based on the multidimensional data and the principal component;
generating a guide line based on a first group of parameters among the plurality of parameters and a second group of parameters among the plurality of parameters; and
generating, using the machine learning processor, an analysis result of a parameter among the plurality of parameters of the wafer based on the data plane, the guide line, and the loading vector.

18. The data processing method of claim 17, wherein:
the data plane comprises a biplot that includes points and an arrow, wherein the points represent the multidimensional data and the arrow represents the loading vector.

19. The data processing method of claim 17, further comprising:
generating a plurality of loading vectors; and
ranking the plurality of loading vectors based on a similarity between the guide line and each of the plurality of loading vectors.

20. The data processing method of claim 17, wherein:
an axis of the data plane represents the principal component.
